(19) United States
(12) Patent Application Publication
(10) Pub. No.: US 2016/0104266 A1
(43) Pub. Date: Apr. 14, 2016

(54) DISPLAY APPARATUS AND DISPLAY METHOD

(71) Applicant: SAMSUNG ELECTRONICS CO., LTD., Suwon-si (KR)

(72) Inventors: Woo-seok HWANG, Seoul (KR); Yoo-jin CHOI, Seoul (KR); Jang-won SEO, Seoul (KR); Yong-hwan KWON, Seongnam-si (KR)

(21) Appl. No.: 14/881,780

(22) Filed: Oct. 13, 2015

(30) Foreign Application Priority Data
Oct. 13, 2014 (KR) 10-2014-0137549

(51) Int. Cl. G06T 5/00; G06T 7/00; G06T 7/40; G06K 9/46

(52) U.S. Cl. CPC G06T 5/001; G06K 9/4604; G06T 7/0081; G06T 7/408; G06T 2207/10024

(57) ABSTRACT

A display apparatus and a display method thereof are provided. The display method includes extracting a representative color of a first region of a display image, determining a color of a second region associated with the first region using the extracted representative color, and displaying the second region using the determined color.

### CROSS-REFERENCE TO RELATED APPLICATION

This application is based on and claims priority under 35 U.S.C. §119 to Korean Patent Application No. 10-2014-0137549, filed on Oct. 13, 2014, in the Korean Intellectual Property Office, the disclosure of which is incorporated herein by reference in its entirety.

### BACKGROUND

1. Field

Apparatuses and methods of the example embodiments relate to a display apparatus and a display method, and for example, to a display apparatus and method capable of increasing and/or improving an image display effect by extracting color of a display image.

2. Description of Related Art

Current display apparatuses may be used as apparatuses which simply display broadcast content as well as central apparatuses of peripheral apparatuses through connections with various apparatuses. Additionally, a variety of content on the web may be viewed in the current display apparatuses through Internet connection. The display apparatuses such as televisions (TVs) are also evolved into smart TVs which may improve usability through installation of various applications.

Due to the increase in content which may be used through the display apparatuses, such as content provided from the display apparatuses or content received from external apparatuses and the like, the importance of a user interface (UI) which easily searches for and classifies content to be used by the user is increased.

Therefore, there is a need for a method capable of obtaining various visual effects for easily sorting content and easily recognizing information for the content by the user.

### SUMMARY

Example embodiments may overcome the above disadvantages and other disadvantages not described above.

One or more example embodiments relate to a display apparatus and/or method capable of increasing and/or improving an image display effect by extracting color of a display image and using the extracted color.

According to an aspect of an example embodiment, a display method for a display apparatus is provided, the method including extracting a representative color of a first region of a display image; determining a color of a second region associated with the first region using the extracted representative color; and displaying the second region using the determined color.

The first region may, for example, be a region in which a thumbnail image is displayed, and the second region may, for example, be a region which displays information related to the thumbnail image.

The first region may, for example, be an entire image which displays content, and the second region may, for example, be a region which displays a user interface (UI) related to the content inside the entire image.

The method may further include acquiring a capture image by capturing moving image content displayed in the display image and extracting a representative color of a first region of the capture image.

Acquiring the capture image may include capturing the moving image content at a preset time interval.

Extracting may include extracting the representative color in a partial region inside the first region based on a preset ratio.

The partial region may be determined based on a direction in which the second region is located with respect to the location of the first region.

Extracting may include dividing the first region by a preset number, extracting color values of the divided regions, and extracting the representative color using an average value of the extracted color values.

Determining a color of the second region may include determining the color of the second region by changing at least one of saturation, brightness, and transparency of the extracted representative color or blending a preset color with the extracted representative color.

According to an aspect of an example embodiment, a display method for a display apparatus is provided, the method including extracting a representative color of a display item; determining a color of a region which displays information related to the display item using the extracted representative color; and displaying the region which displays the related information using the determined color.

According to an aspect of an example embodiment, a display apparatus is provided including a display configured to display an image; and a controller configured to extract a representative color of a first region of the displayed image, determine a color of a second region associated with the first region using the extracted representative color, and to control the display to display the second region using the determined color.

The first region may, for example, be a region in which a thumbnail image is displayed, and the second region may, for example, be a region which displays information related to the thumbnail image.

The first region may, for example, be an entire image which displays content, and the second region may, for example, be a region which displays a user interface (UI) related to the content inside the entire image.

The controller may be configured to acquire a capture image by capturing moving image content displayed in the displayed image, and extract a representative color of a first region of the capture image.

The controller may be configured to acquire the capture image by capturing the moving image content at a preset time interval.

The controller may be configured to extract the representative color in a partial region inside the first region based on a preset ratio.

The partial region may be determined based on a direction in which the second region is located with respect to the location of the first region.

The controller may be configured to divide the first region by a preset number, extract color values of the divided regions, and extract the representative color using an average value of the extracted color values.

The controller may be configured to determine the color of the second region by changing at least one of saturation, brightness, and transparency of the extracted representative color or blending a preset color with the extracted representative color.

According to an aspect of an example embodiment, a display apparatus is provided including a display configured to display a display item; and a controller configured to extract a representative color of the display item, determine a color of a region which displays information related to the display item using the extracted representative color, and to control the display to display the region which displays the related information using the determined color.

According to various example embodiments, a display apparatus and method which increases and/or improves an image display effect by extracting color of a display image and using the extracted color, and a display method may be provided.

Additional aspects and advantages of the example embodiments are set forth in the detailed description.

### BRIEF DESCRIPTION OF THE DRAWINGS

The above and/or other aspects and advantages of the example embodiments will become more apparent from the following detailed description taken in conjunction with the accompanying drawings, in which like reference numerals refer to like elements, and wherein:

FIG. 1 is a block diagram illustrating a configuration of a display apparatus according to an example embodiment;

FIG. 2 is a diagram illustrating a method of determining an average color value in pixels of an entire display image according to an example embodiment;

FIG. 3 is a diagram illustrating a method of resizing a display image and determining an average color value of the display image according to an example embodiment;

FIG. 4 is a diagram illustrating a method of dividing a display image in a preset size, and determining an average color value according to an example embodiment;

FIGS. 5A and 5B are diagrams illustrating a method of determining an average color in a partial region inside a display image according to an example embodiment;

FIG. 6 is a diagram illustrating a plurality of thumbnail images and information regions of the thumbnail images according to an example embodiment;

FIG. 7 is a diagram illustrating moving image content and a UI included inside the moving image content according to an example embodiment;

FIG. 8 is a diagram illustrating a method of extracting a representative color of a display image by dividing a display screen according to an example embodiment; and

FIGS. 9 and 10 are flowcharts illustrating display methods of a display apparatus according to example embodiments.

### DETAILED DESCRIPTION

Hereinafter, the example embodiments are described in greater detail with reference to the accompanying drawings.

In the following description, unless otherwise described, the same reference numerals are used for the same elements when they are depicted in different drawings. The matters defined in the description, such as detailed construction and elements, are provided to assist in understanding of the example embodiments. Thus, it is understood that the example embodiments can be carried out without those specifically defined matters. Also, functions or elements known in the related art are not described in detail since they may obscure the example embodiments with unnecessary detail.

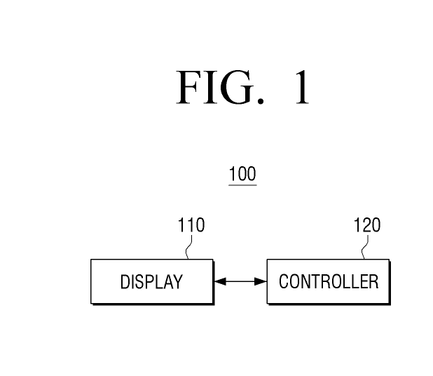

FIG. 1 is a block diagram illustrating a configuration of a display apparatus 100 according to an example embodiment. As illustrated in FIG. 1, the display apparatus 100 may include a display 110 and a controller 120. The display apparatus 100 may, for example, be a television (TV), but this is merely an example. The display apparatus 100 may be implemented with various electronic apparatuses including the display 110 such as, for example, a portable phone, a tablet personal computer (PC), a digital camera, a camcorder, a laptop PC, a personal digital assistant (PDA), or the like.

The display 110 may be configured to display an image. The display 110 may display content received through a broadcasting channel. For example, the display apparatus 100 may receive various broadcast signals transmitted from a broadcasting station through a radio frequency (RF) communication network. In another example, the display apparatus 100 may receive content from various servers through an Internet protocol (IP) network. The display 110 may display the received content.

The display 110 may display various UIs. For example, the display 110 may display a UI configured to display a variety of content which may be displayed through the display apparatus 100 and information of the content. The display 110 may display the various UIs through various menus provided from the display apparatus 100. The display 100 may simultaneously display the UIs while displaying still image content and/or moving image content.

The display 110 may have a size in which a ratio of a width to a height is 16:9 to support full high definition (HD)-graded resolution of 1920×1080. However, this is merely an example, and the display 110 may have a size in which the ratio of the width to the height is 21:9 or any other desirable ratio.

The controller 120 may be configured to control an overall operation of the display apparatus 100. The controller 120 may be configured to extract a representative color of a first region of the display image displayed in the display 110. The controller 120 may be configured to determine a color of a second region associated with the first region using the extracted representative color, and to control the display 110 to display the second region using the determined color.

The controller 120 may be configured to extract a representative color for a certain display item displayed in the display 110, and to determine a color of a region which displays information related to the display item using the extracted representative color. The controller 120 may be configured to control the display 110 to display the region which displays the related information using the determined color.

For example, the first region may be a region in which a thumbnail image displayed through the display 110 is displayed, and the second region may be a region which displays information related to the thumbnail region. In another example, the first region may be an entire image which displays content, and the second region may be a region which displays a UI related to the content inside the entire image.

In response to moving image content being displayed through the display 110, the controller 120 may be configured to acquire a capture image by capturing the moving image content, and to extract a representative color of a first region in the capture image. The controller 120 may be configured to capture the moving image content at a preset time interval.

The controller 120 may be configured to extract the representative color through various methods. For example, the controller 120 may be configured to extract the representative color in a partial region inside the first region. The controller 120 may be configured to select the partial region according to a direction in which the second region is located with respect to the location of the first region. The controller 120 may be configured to select the partial region at a certain ratio.

In another example, the controller 120 may be configured to divide the first region by a preset number, to extract color values of the divided regions, and to extract a color having an average value of the extracted color values as the representative value.

The controller 120 may be configured to determine the representative color of the color of the second region. In another example, the controller 120 may be configured to determine the color of the second region by changing saturation, brightness, transparency, and like of the representative color or by blending a preset color with the extracted representative color at a certain ratio.

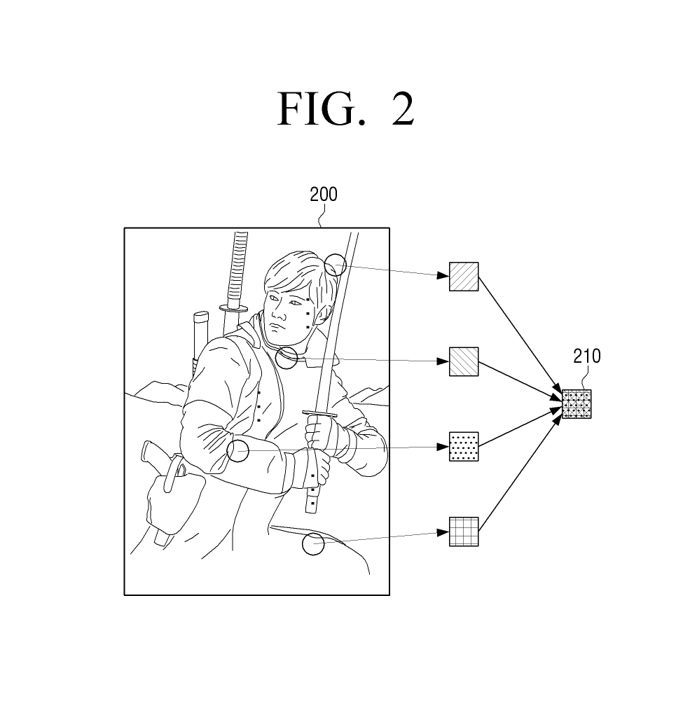

A method of extracting the representative color will be described with reference to FIGS. 2 to 4.

FIG. 2 is a diagram illustrating a method of determining an average color value for pixels of an entire display image 200 of the display 110. The display image 200 may be an image which is displayed in a portion of the display 110 or the entire display 110.

The controller 120 may be configured to extract the representative color for pixels of the entire display image 200 displayed in the display 110 such as a still image, a thumbnail image, or a capture image.

In response to the display image 200 being an image displayed in the portion of the display 110, the controller 120 may be configured to accurately determine a boundary of the display image 200 in which the representative color is to be extracted. The controller 120 may be configured to divide the display image 200 into R, G, and B colors, and to calculate average values for the R, G, and B colors.

For example, the controller 120 may be configured to extract the average color value for the R color by detecting color values of the R color for allpixels and calculating the average value of the detected color values. The controller 120 may be configured to extract the average color values for the G and B colors in a similar manner. The controller 120 may be configured to extract a representative color 210 using the extracted average values for the R, G, and B colors.

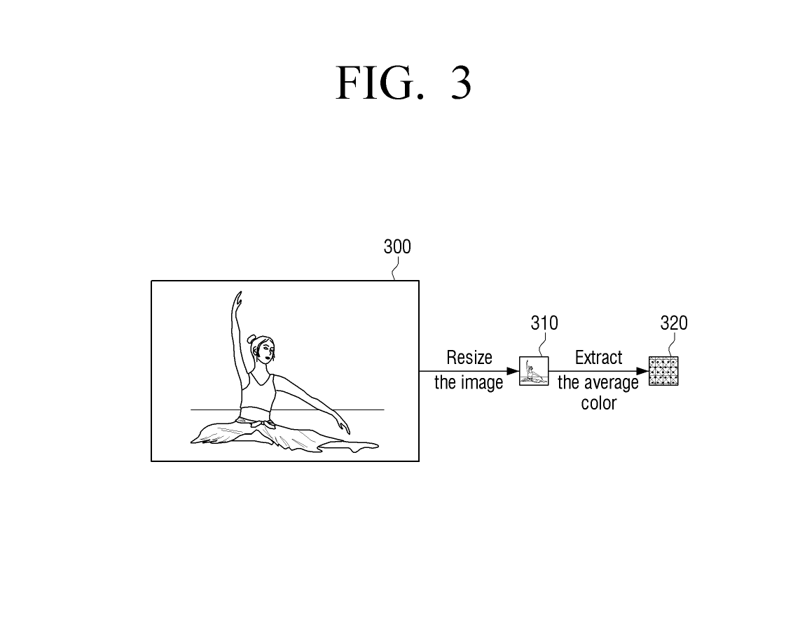

As illustrated in FIG. 3, the controller 120 may be configured to perform an operation which changes a size of a display image 300 and then to extract a representative color.

For example, the controller 120 may be configured to determine a boundary of the display image 300 in which the representative color is to be extracted with respect to an image displayed in the entire display 110 or an image displayed in the portion of the display 110. The controller 120 may be configured to reduce a size of the determined display image 300. For example, the controller 120 may be configured to reduce the size of the display image 300 to, for example, one-tenth of the original size. The controller 120 may be configured to extract a representative color 320 for a reduced display image 310 through the method as illustrated, for example in FIG. 2.

For example, the controller 120 may be configured to divide the reduced display image 310 into R, G, and B colors and calculate average values for the R, G, and B colors. For example, the controller 120 may be configured to extract the average color value for the R color by detecting color values of the R color for all pixels and calculating the average value of the detected color values. The controller 120 may be configured to extract the average color values for the G and B colors. The controller 120 may be configured to extract a representative color 320 using the extracted average values for the R, G, and B colors.

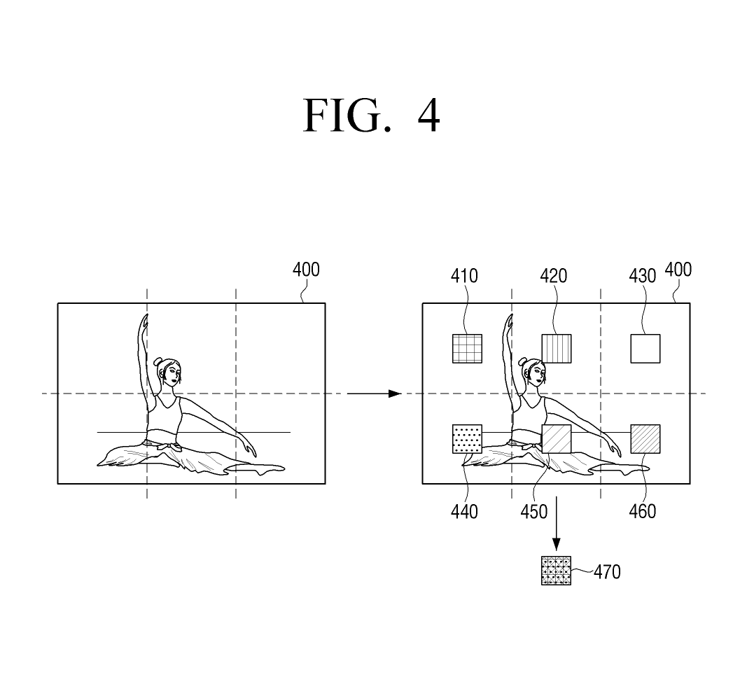

As illustrated in FIG. 4, the controller 120 may be configured to extract a representative color by dividing a display image 400.

For example, the controller 120 may be configured to set a division number for dividing a region of the display image 400 according to a size and resolution of the display image 400, a setup of the display apparatus 100, and the like.

The controller 120 may be configured to divide the display image 400 determined to the region in which the representative color is to be extracted by the preset division number. For example, FIG. 4 illustrates an example in which the display region 400 is divided into six regions, but this is merely an example. The display region 400 may be variously divided into any desired number of regions, such as, for example, nine regions, sixteen regions, or the like.

The controller 120 may be configured to extract representative colors 410 to 460 in the divided regions through the above-described method. For example, the controller 120 may be configured to divide a first region into R, G, and B colors and calculate average values for the R, G, and B colors. For example, the controller 120 may be configured to extract the average color value for the R color by detecting color values of the R color for all pixels in a region and calculating the average value of the detected color values. The controller 120 may be configured to extract the average color values for the G and B colors in a similar manner. The controller 120 may be configured to extract the representative color 410 of the first region using the extracted average values for the R, G, and B colors in the first region 410. Similarly, the controller 120 may be configured to extract the representative colors 420 to 460 for the remaining regions other than the first region in a similar manner.

The controller 120 may be configured to extract a representative color 470 of the display image 400 by calculating an average value of color values of at least one of representative colors 410 to 460 extracted in the regions.

In another example, the controller 120 may be configured to extract the representative color 470 by excluding partial color values having the largest deviation value among the color values of the plurality of representative colors 410 to 460 extracted in the plurality of regions.

However, the method of extracting the representative color is not limited to the above-described methods, and various methods for extracting a representative color of a display image may be used according to a kind, setup, and the like of the display apparatus 100.

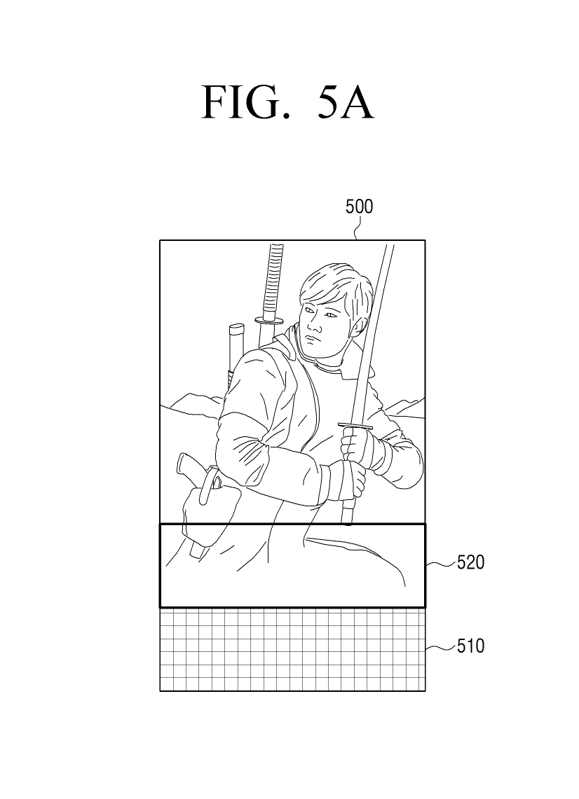

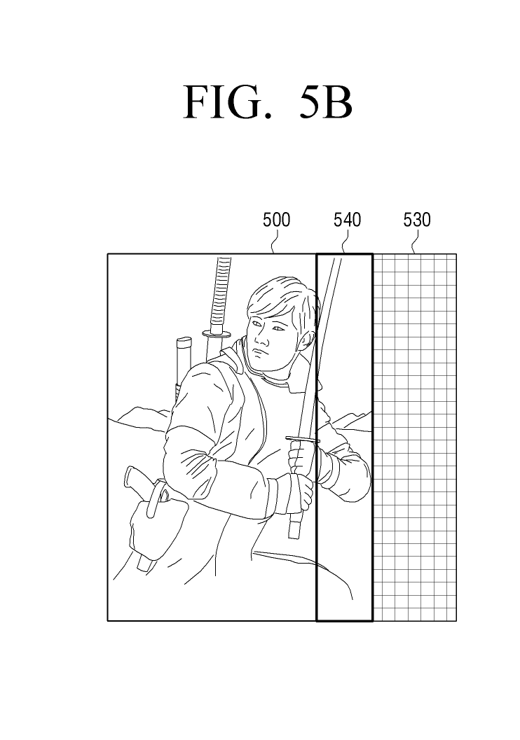

FIGS. 5A and 5B are diagrams illustrating a method of calculating an average color in a partial region inside the display image according to an example embodiment.

For example, FIGS. 5A and 5B are diagrams illustrating a thumbnail image 500 and information regions 510 and 530 close to one end of the thumbnail image 500. The information regions 510 and 530 may be regions which display information related to the thumbnail image 500, for example, a variety of information such as a title, a producing country, a producer, manufacturing year, a cast, and a genre of content corresponding to the thumbnail image.

The controller 120 may be configured to display the information regions 510 and 530 by extracting a representative color of the thumbnail image 500 and using the extracted representative color to represent the thumbnail image 500 and the information regions 510 and 530 to provide a sense of unity.

For example, the controller 120 may be configured to extract the representative color through the methods as described, for example, in FIGS. 2 to 4 and to display the information regions 510 and 530. In another example, the controller 120 may be configured to display the information regions 510 and 530 by extracting a representative color for a partial region of the thumbnail image 500 as illustrated in FIGS. 5A and 5B.

For example, the controller 120 may be configured to determine a partial region of the thumbnail image 500 for extracting the representative color according to positions of the information regions 510 and 530. As illustrated in FIG. 5A, in response to the information region 510 being located in a bottom of the thumbnail image 500, the controller 120 may be configured to extract a representative color for a partial region 520 located at the bottom of the thumbnail image 500.

As illustrated in FIG. 5B, in response to the information region 530 being located in the right of the thumbnail image 500, the controller 120 may be configured to extract a representative color for a partial region 540 located to the right of the thumbnail image 500.

Although not shown in FIGS. 5A and 5B, the information region may, for example, be located in a top and left of the thumbnail image 500 and may, for example, have a shape to surround the thumbnail image 500. The information region may, for example, be located in a central portion of the thumbnail image 500.

The controller 120 may be configured to determine a ratio of the region 520 for extracting the representative color at the bottom of the thumbnail image 150. For example, the controller 120 may be configured to determine the ratio of the region for extracting the representative color to be more than 0 (zero) % and to be equal to or less than 100% according to a user setup, an initial setup of the display apparatus 100, characteristics of the display image such as the thumbnail image 500, and the like.

The controller 120 may be configured to determine the position and ratio of the region for extracting the representative color inside the thumbnail image 500, and to extract the representative color according to the determined position and ratio of the region. The controller 120 may be configured to determine colors of the information regions 510 and 530 using the extracted representative color. Even in response to text being included in the information regions 510 and 530, the controller 120 may be configured to determine the color of the text using the representative color.

For example, the controller 120 may be configured to display the information regions 510 and 530 with the extracted representative color, and determine colors of the text, an icon, a widget, and the like in the information regions 510 and 530 by controlling characteristics of the extracted representative color such as, for example, saturation.

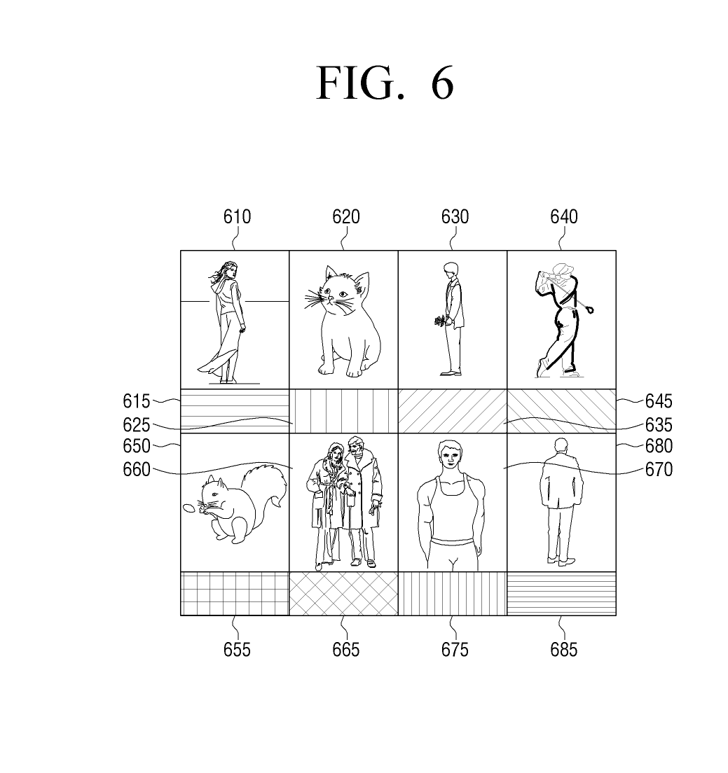

FIG. 6 is a diagram illustrating a plurality of thumbnail images and information regions thereof according to an example embodiment. Through the above-described various methods, the controller 120 may, for example, be configured to extract representative colors of a plurality of thumbnail images 610, 620, . . . , 670, and 680, and display information regions 615, 625, . . . , 675, and 685 of the thumbnail images 610, 620, . . . , 670, and 680 using the extracted representative colors together with the thumbnail images 610, 620, . . . , 670, and 680.

As illustrated in FIG. 6, in response to the information regions 615, 625, . . . , 675, and 685 of the thumbnail images 610, 620, . . . , 670, and 680 being displayed using the representative colors of the thumbnail images 610, 620, . . . , 670, and 680, the user may easily see whether the information regions display information corresponding to each of the thumbnail images. The user may recognize a thumbnail image and an information region corresponding thereto, for example, the thumbnail 610 and the information region 615 as one item.

The controller 120 may be configured to display the information regions by changing attributes of the extracted representative colors. For example, the controller 120 may be configured to change the attributes of the extracted representative colors such as saturation, brightness, and transparency, and display the information regions with the changed colors.

The controller 120 may be configured to blend the same preset color with the extracted representative colors at the same ratio, and to display the information regions with the changed colors. For example, the controller 120 may be configured to blend white with the extracted representative colors at the ratio of 5% or any other desired ratio. The controller 120 may be configured to display the information regions with the blended colors.

Therefore, the user who views the displayed entire thumbnails and entire information regions may feel or observe a sense of unity.

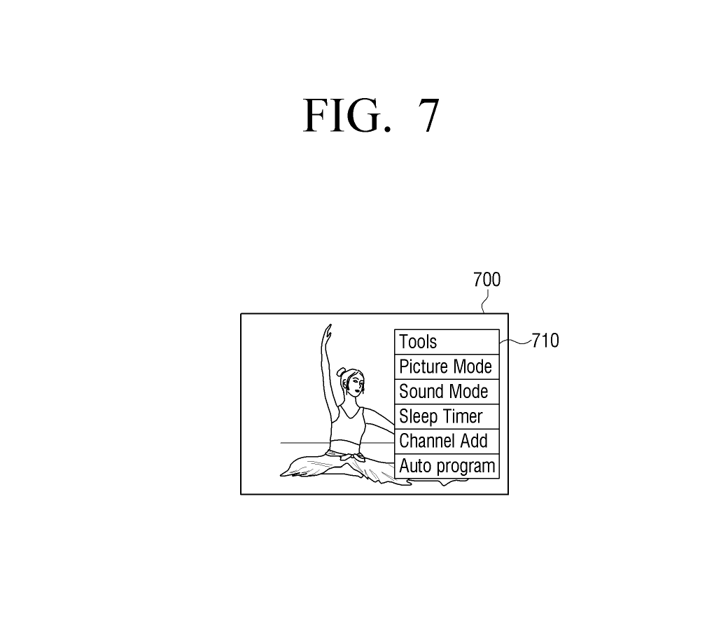

FIG. 7 is a diagram illustrating moving image content and a UI included inside the moving image content according to an example embodiment.

In response to the moving image content being displayed through the display 110, the controller 120 may be configured to acquire a capture image 700 by capturing the moving image content, and to extract a representative color of an entire region or a partial region of the capture image 700.

In response to the moving image content being displayed, the controller 120 may be configured to capture the moving image content at a preset time interval. For example, the controller 120 may be configured to capture the moving image content at intervals of six seconds.

The controller 120 may be configured to extract the representative color for the capture image 700 through the above-described methods. For example, the controller 120 may be configured to extract the representative color for the capture image 700 by extracting color values for entire pixels of the capture image 700, and calculating an average value of the extracted color values. In another example, the controller 120 may be configured to determine a region in which the representative color is to be extracted according to a position of a UI 710 to be displayed inside the capture image 700, and to extract the representative color in the determined region.

The controller 120 may be configured to display the UI 710 using the extracted representative color. For example, the controller 120 may be configured to display a wallpaper of the UI 710 with the extracted representative color, and to display contents such as text, a widget, an icon inside the UI 710 with a color in which the attribute of the extracted representative color such as, for example, the saturation is changed.

Since the UI 710 is displayed to overlap the moving image content while the moving image content is displayed, the controller 120 may be configured to display the wallpaper of the UI 700 by controlling the transparency of the extracted representative color. For example, the controller 120 may be configured to display the wallpaper of the UI 710 by setting the transparency of the extracted representative color to 50%, and display text inside the UI 710 with the extracted representative color.

The UI 710 may be an on screen display (OSD) which displays information including a variety of information such as a title, a director, a producing country, a producer, a hero, or producing year, a menu for selecting other content, an icon indicating an application, a widget, or a display setup, or the like, of the display apparatus 100.

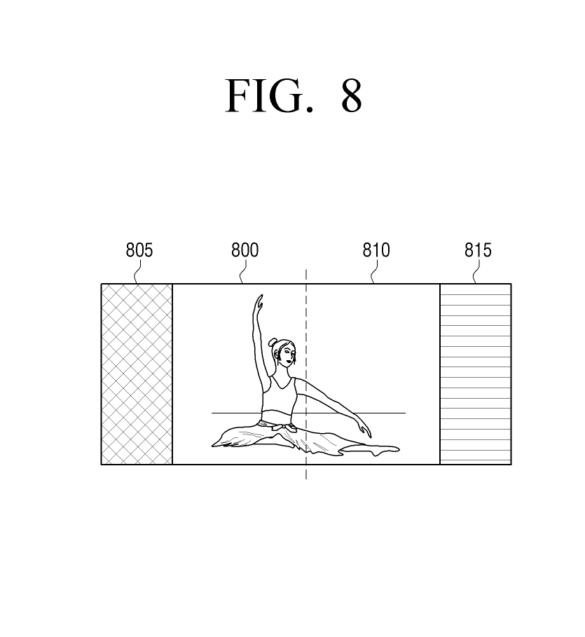

FIG. 8 is a diagram illustrating a method of extracting a representative color of a display image by dividing a display screen according to an example embodiment.

For example, an image which is displayed in the display 110 is displayed at the ratio of 16:9 such as full HD. However, in response to the display 110 having a size of a ratio (for example, the ratio of 21:9 or any other desired ratio) different from the ratio of the image, the controller 120 may be configured to display a region other than the displayed image using the representative color.

The controller 120 may be configured to extract a representative color for an entire region of the displayed image, and display regions 805 and 815 other than the displayed image with the extracted representative color. In response to the displayed image being moving image content, the controller 120 may be configured to change the colors of the regions 805 and 815 other than the displayed image by extracting the representative color at a preset time interval.

In another example, the controller 120 may be configured to divide the entire region of the displayed image into a plurality of regions, extract representative colors for the divided regions, and display the regions 805 and 815 other than the displayed image with the extracted representative colors.

For example, the controller 120 may be configured to vertically divide the displayed image by two, and extract the representative colors of the divided regions 800 and 810. The controller 120 may be configured to display the region 805 closed to the first region 800 with the color extracted in the first region 800, and display the region 815 close to the second region 810 with the color extracted in the second region 810. In another example, in response to the displayed image being moving image content, the controller 120 may be configured to extract the representative colors in the plurality of divided regions at a preset time interval, and to change the colors of the regions 805 and 815 other than the displayed image.

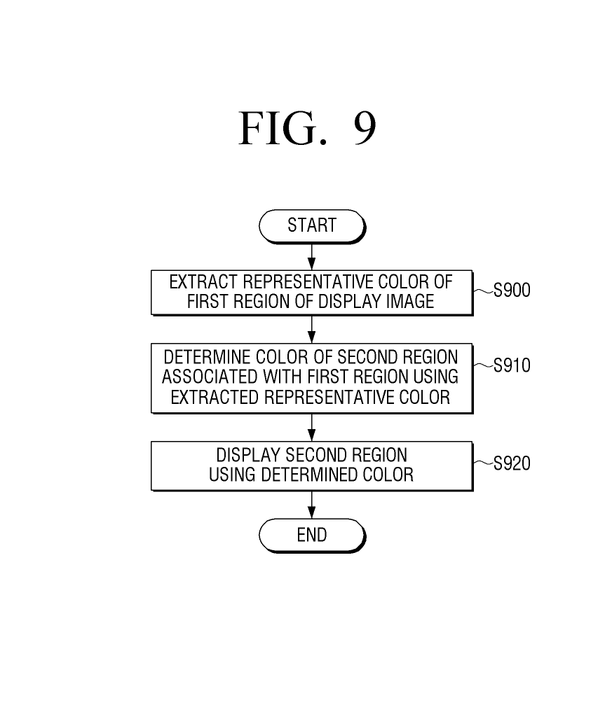

FIG. 9 is a flowchart illustrating a display method for a display apparatus according to an example embodiment. The display apparatus 100 may extract a representative color of a first region of a display image (S900).

The display image may, for example, be a still image or a capture image in which one frame of a moving image is captured. The first region may, for example, be a region displayed in an entire display of the display apparatus 100. However, this is merely an example, and the first region may be a partial region of the displayed image or any desired region.

For example, the display apparatus 100 may extract the representative color for the first region corresponding to the entire region or partial region of the displayed image. Any method of extracting one color as the representative color may be used as the method of extracting the representative color. For example, the display apparatus 100 may extract the representative color by averaging color values of pixels included in the first region or by averaging color values of pixels included in a partial region of the first region.

The display apparatus 100 may determine a color of a second region associated with the first region using the extracted representative color (S910). For example, the second region may be a region close to the first region, a region surrounding the first region, or a region inside the first region. In another example, the second region may be an information region for displaying information for content included in the first region or a region for displaying a setup menu.

The display apparatus 100 may display the second region using the determined color (S920). For example, the display apparatus 100 may display the second region with the extracted representative color. In another example, the display apparatus 100 may change color characteristics of the extracted representative color such as saturation, brightness, and transparency, and display the second region with the changed color. In response to text, a widget, an icon, and the like being included in the second region, the display apparatus 100 may also determine colors of the text, widget, icon, and the like included in the second region using the representative color.

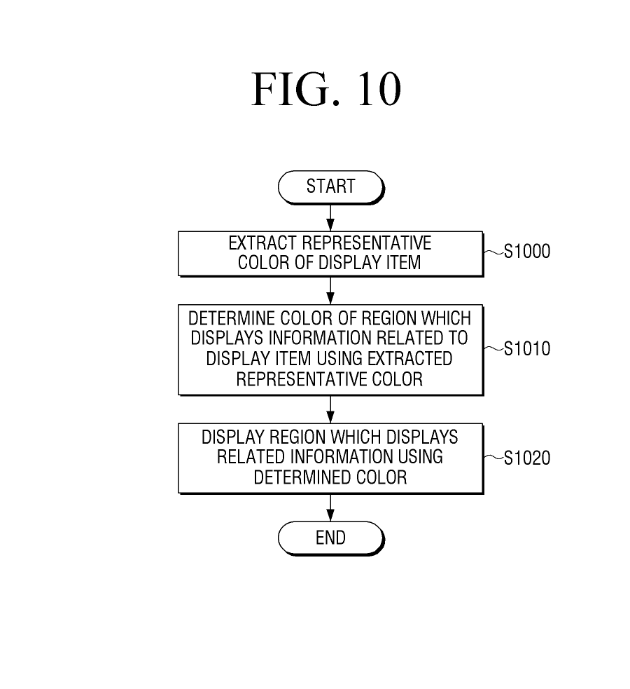

FIG. 10 is a flowchart illustrating a display method for a display apparatus according to an example embodiment. In FIG. 10, a display item may correspond to the first region in FIG. 9, and a region which displays information may correspond to the second region in FIG. 9.

The display apparatus 100 may extract a representative color of a display item (S1000). The display item may be a thumbnail image for indicating content. For example, the display apparatus 100 may determine the display item in which the representative color is to be extracted among various pieces of displayed content, and extract the representative color which represents the determined display item. Any method of extracting one color as the representative color may be used as the method of extracting the representative color. For example, the display apparatus 100 may extract the representative color by averaging color values of pixels included in the display item or by averaging color values of pixels included in a partial region of the display item.

The display apparatus 100 may determine a color of a region which displays information related to the display item using the extracted representative color (S1010). For example, in response to the display item being a thumbnail image which is a representative image corresponding to content, the display apparatus 100 may display the region which displays the information related to the display item near the display item.

For example, the display apparatus 100 may display a variety of information such as a title, a producing country, a producer, producing year, a cast, or a genre of the content corresponding to the thumbnail image in a bottom of the thumbnail image.

Therefore, the display apparatus 100 may determine the color of the region for displaying the information using the extracted representative color.

The display apparatus 100 may display the region which displays the related information using the determined color (S1020). For example, the display apparatus 100 may display the information represented with the extracted representative color in the region for displaying the information. In another example, the display apparatus 100 may change color characteristics of the extracted representative color such as saturation, brightness, and transparency, and display the information represented with the changed color in the region for displaying the information. In response to text, a widget, an icon, and the like being included in the region for displaying the information, the display apparatus 100 may also determine colors of the text, widget, icon, and the like included in the region for displaying the information using the representative color.

The user may easily visually recognize information for content through the display methods of the display apparatus 100 as described above.

The display method for a display apparatus according to example embodiments may be coded in software, and stored in a non-transitory readable medium. The non-transitory readable medium may be installed in various apparatuses and used. Furthermore, as will be appreciated by those skilled in the art, the described systems, methods and techniques may be implemented in digital electronic circuitry including, for example, electrical circuitry, logic circuitry, hardware, computer hardware, firmware, software, or any combinations of these elements. Apparatus embodying these techniques may include appropriate input and output devices, a computer processor, and a computer program product tangibly embodied in a non-transitory machine-readable storage device or medium for execution by a programmable processor. A process embodying these techniques may be performed by a programmable hardware processor executing a suitable program of instructions to perform desired functions by operating on input data and generating appropriate output. The techniques may be implemented in one or more computer programs that are executable on a programmable processing system including at least one programmable processor coupled to receive data and instructions from, and transmit data and instructions to, a data storage system, at least one input device, and at least one output device. Each computer program may be implemented in a high-level procedural or object-oriented programming language or in assembly or machine language, if desired; and in any case, the language may be compiled or interpreted language. Suitable processors include, by way of example, both general and special purpose microprocessors. Generally, a processor will receive instructions and data from a rea-only memory and/or a random access memory. Non-transitory storage devices suitable for tangibly embodying computer program instructions and data include all forms of computer memory including, but not limited to, non-volatile memory, including by way of example, semiconductor memory devices, such as Erasable Programmable Read-Only Memory (EPROM), Electrically Erasable Programmable Read-Only Memory (EEPROM), and flash memory devices; magnetic disks, such as internal hard disks and removable disks; magneto-optical disks; Compact Disc Read-Only Memory (CD-ROM), digital versatile disk (DVD), Blu-ray disk, universal serial bus (USB) device, memory card, or the like. Any of the foregoing may be supplemented by, or incorporated in, specially designed hardware or circuitry including, for example, application-specific integrated circuits (ASICs) and digital electronic circuitry. Thus, methods for providing image contents described above may be implemented by a program including an executable algorithm that may be executed in a computer, and the program may be stored and provided in a non-transitory computer readable medium.

The non-transitory readable medium is not a medium configured to temporarily store data such as a register, a cache, or a memory but an apparatus-readable medium configured to permanently or semi-permanently store data. For example, non-transitory apparatus-readable medium may include a compact disc (CD), a digital versatile disc (DVD), a hard disc, a Blu-ray disc, a universal serial bus (USB), a memory card, a read only memory (ROM), and the like.

The foregoing example embodiments and advantages are provided merely for purposes of illustration and are not to be construed as limiting the disclosure. The example embodiments can be readily applied to other types of devices. Also, the description of the example embodiments is intended to be illustrative only, and not to limit the scope of the claims, and many alternatives, modifications, and variations will be apparent to those skilled in the art.

What is claimed is:

1. A display method for a display apparatus, comprising:
extracting a representative color of a first region of a display image;
determining a color of a second region associated with the first region using the extracted representative color; and
displaying the second region using the determined color.

2. The method as claimed in claim 1, wherein the first region is a region in which a thumbnail image is displayed, and the second region is a region which displays information related to the thumbnail image.

3. The method as claimed in claim 1, wherein the first region is an image which displays content, and the second region is a region which displays a user interface (UI) related to the content inside the image.

4. The method as claimed in claim 1, further comprising acquiring a capture image by capturing moving image content displayed in the display image; and
extracting a representative color of a first region of the capture image.

5. The method as claimed in claim 4, wherein acquiring the capture image includes capturing the moving image content at a preset time interval.

6. The method as claimed in claim 1, wherein extracting includes extracting the representative color in a partial region inside the first region based on a preset ratio.

7. The method as claimed in claim 6, wherein the partial region is determined based on a direction in which the second region is located with respect to the location of the first region.

8. The method as claimed in claim 1, wherein extracting includes:
dividing the first region by a preset number;
extracting color values of the divided regions; and
extracting the representative color using an average value of the extracted color values.

9. The method as claimed in claim 1, wherein determining includes determining the color of the second region by changing at least one of saturation, brightness, and transparency of the extracted representative color or blending a preset color with the extracted representative color.

10. A display method for a display apparatus, comprising:
extracting a representative color of a display item;
determining a color of a region which displays information related to the display item using the extracted representative color; and
displaying the region which displays the related information using the determined color.

11. A display apparatus comprising:
a display configured to display an image; and
a controller configured to extract a representative color of a first region of the displayed image, to determine a color of a second region associated with the first region using the extracted representative color, and to control the display to display the second region using the determined color.

12. The display apparatus as claimed in claim 11, wherein the first region is a region in which a thumbnail image is displayed, and the second region is a region which displays information related to the thumbnail image.

13. The display apparatus as claimed in claim 11, wherein the first region is an image which displays content, and the second region is a region which displays a user interface (UI) related to the content inside the image.

14. The display apparatus as claimed in claim 11, wherein the controller is configured to acquire a capture image by capturing moving image content displayed in the displayed image, and to extract a representative color of a first region of the capture image.

15. The display apparatus as claimed in claim 14, wherein the controller is configured to acquire the capture image by capturing the moving image content at a preset time interval.

16. The display apparatus as claimed in claim 11, wherein the controller is configured to extract the representative color in a partial region inside the first region based on a preset ratio.

17. The display apparatus as claimed in claim 16, wherein the partial region is determined based on a direction in which the second region is located with respect to the location of the first region.

18. The display apparatus as claimed in claim 11, wherein the controller is configured to divide the first region by a preset number, to extract color values of the divided regions, and to extract the representative color using an average value of the extracted color values.

19. The display apparatus as claimed in claim 11, wherein the controller is configured to determine the color of the second region by changing at least one of saturation, brightness, and transparency of the extracted representative color or blending a preset color with the extracted representative color.

20. A display apparatus comprising:
a display configured to display a display item; and
a controller configured to extract a representative color of the display item, to determine a color of a region which displays information related to the display item using the extracted representative color, and to control the display to display the region which displays the related information using the determined color.
